(19) United States
(12) Patent Application Publication
(10) Pub. No.: US 2009/0006199 A1
(43) Pub. Date: Jan. 1, 2009

(54) Advertisement application server in IP multimedia subsystem (IMS) network

(76) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/900,681

(22) Filed: Sep. 13, 2007

(30) Foreign Application Priority Data
Jun. 29, 2007 (CN) 200710112271.6

(51) Int. Cl. G06Q 30/00; G06F 17/30; G06F 17/40

(52) U.S. Cl. 705/14

(57) ABSTRACT

In an advertisement system for an IMS (IP Multimedia Subsystem) network, multimedia advertisements are transmitted to end-user terminals according to three available advertising service functions: when a user terminal calls a designated phone number; when the system calls a user terminal, typically during a user-designated time window; and when a first user terminal calls a second user terminal, in the time period before the call is answered. The system includes an advertisement application server, which coordinates and manages operation of the system, and an advertisement media server, which stores and transmits the advertisement data to end-user terminals. In operation, upon determining to transmit advertisements to a user terminal, a link is established with the terminal. Multimedia advertising data (including picture/video content and audio content) is then transmitted from the media server to the user terminal over the IMS network. Users may be awarded service credits for viewing advertisements.

This application is entitled to the benefit of and claims foreign priority under 35 U.S.C. § 119 from Chinese Patent Application No. 200710112271.6, filed Jun. 29, 2007, the disclosure of which is hereby incorporated by reference.

### FIELD OF THE INVENTION

The present invention relates to communications and, more particularly, to services for delivering content in an IMS-based network or other communication network.

### BACKGROUND OF THE INVENTION

Because large numbers of people now access information and communication services on a regular basis (e.g., telephone and Internet), communication service providers have more frequently begun to utilize various advertising models to generate income. Thus, for example, on a free-content website, it is often the case that one or more static banner advertisements, animated banner advertisements, and/or video-type advertisements (e.g., FLASH-format video) will be displayed in addition to the user content. Advertisers may pay for the advertisements to be displayed generally, and/or on a “per-click” basis when viewers select the advertisements for obtaining more information.

For telephone communications, advertising-based business models have heretofore been very limited in scope. For example, in one system, audio advertisements are played back to a user when the user calls a designated telephone number. The telephony service provider monitors the advertisement consumption activities of the user, and may credit the user with telephony service credits in accordance with the observed advertisement consumption activities. (In other words, the user is given phone service credits or other value for listening to the audio advertisements.) Such systems are particularly limited, however, in that the advertisements are audio-only, and in that they require the user to call a designated phone number for listening to the advertisements. Also, there is no way for the user or service provider to customize the advertisement service with respect to particular user characteristics or preferences.

### SUMMARY OF THE INVENTION

An embodiment of the present invention relates to a method and system for communicating with a terminal over an IMS (IP Multimedia Subsystem) or other network, e.g., for delivering multimedia advertisements or similar content to end-user terminals. By “terminal,” it is meant an electronic device capable of communicating with other devices over a network, including, for example, computers and wireless units such as mobile phones, wireless PDA's, wireless devices with high-speed data transfer capabilities, such as those compliant with “3-G” or “4-G” standards, “WiFi”-equipped computer terminals, and the like. In operation, a communication link is established with a user terminal over the IMS network. Data is then transmitted to the user terminal. The data includes advertising content for execution on the user terminal. Here, “execution” means that the user terminal processes the data for playback, display, etc. of an advertisement according to the formatting and type of data present. For example, if the transmitted data is multimedia data that includes advertising-related picture content and sound content, then the sound-content data is processed for playback over the user terminal's audio output, and the picture-content data is processed for display/playback on the user terminal's display, monitor, or other video output.

For implementation of the system on an IMS network, the system includes an advertisement application server and an advertisement media server, both interfaced with the IMS network. The advertisement application server coordinates and manages operation of the system, e.g., for controlling if and when advertisement data is to be transmitted, while the advertisement media server actually transmits the advertisement data to end-user terminals.

In another embodiment, prior to transmitting advertisement data to an end-user terminal, the data is configured based on an advertising profile associated with the terminal. (The advertising profile may be stored, for example, on an IMS network home subscriber server.) By “configured,” it is meant that the data is formatted according to the advertising profile, for reception and execution on the user terminal, and/or that the particular advertisement content of the data is selected based in whole or in part on the profile. For example, the advertising profile may be established and configured by the user of the terminal, for selecting the type/categories of advertisements that the user is interested in receiving.

In one embodiment, multimedia advertisement data is transmitted to the user terminal when the user terminal calls a designated phone number or otherwise initiates communications with a designated communication identifier. The communication identifier is associated in the system with an advertisement playback service. Thus, for example, if the user terminal is a mobile phone, a designated phone number is dialed. Once a connection is established, advertisement data is transmitted to the mobile phone for playback of one or more advertisements. In another embodiment, instead of communications being initiated at the user terminal, the system initiates communications with the user terminal. Typically, this is done within a user-designated time-of-day window, which is a time window within which the user is willing or interested in receiving advertisements over the network. The time-of-day window may be specified in the user's advertising profile stored on the home subscriber server. In another embodiment, advertisement data is transmitted to an end-user terminal when the user terminal initiates communications with another user terminal. The advertisement data is transmitted only until the call/communication is answered at the second terminal. Advertisement data may also be transmitted if the calling terminal is put “on hold.”

In any of the aforementioned embodiments, the system may be configured to keep track of which advertisements are transmitted and executed on the user terminals. Users may then be awarded service credits based on the type and/or number of executed advertisements. “Service credit” refers to monetary or other value redeemable for one or more services over the network, e.g., monetary credit towards the user's monthly bill, free downloads or long distance, and the like.

The system of the present invention implements a multimedia advertisement service for an IMS network or other network, for the transmission and display of multimedia advertisements (e.g., advertisements with picture/video and sound content) on end-user terminals. Advertisements are selected and configured according to user-established profiles, so that users receive advertisements in categories of interest. Users may be given service credits for receiving and displaying the advertisements. The system provides improved flexibility for controlling when advertisements are to be transmitted, including options for (i) the user to call a designated number (or other communication identifier) to receive multimedia advertisements, (ii) the system to automatically transmit advertisements during a time window designated by the user, and/or (iii) the system to transmit advertisements when the user calls another user, in the time period before the call is answered, or during “on hold” situations.

### BRIEF DESCRIPTION OF THE DRAWINGS

The present invention will be better understood from reading the following description of non-limiting embodiments, with reference to the attached drawings, wherein below:

FIG. 1 is a schematic view of a multimedia advertisement system for an IP Multimedia Subsystem (IMS) network;

FIG. 2 is a schematic view of an IMS network;

FIGS. 3A-3C are schematic views of various advertisement service functions of the system; and

FIGS. 4A-4C are flow charts showing one embodiment of the system in operation.

### DETAILED DESCRIPTION

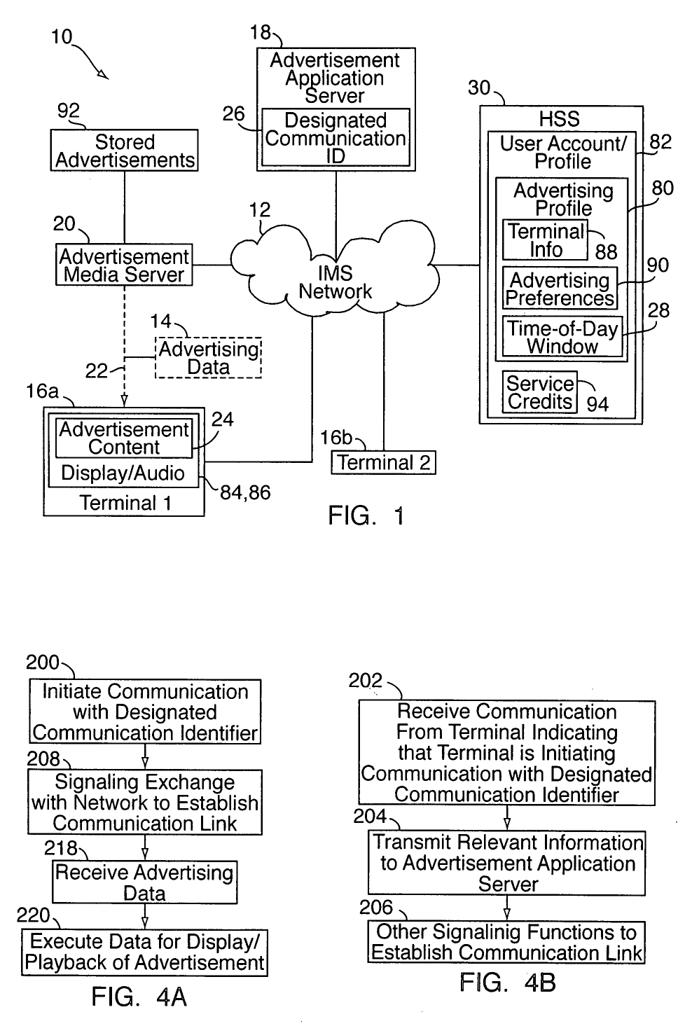

With reference to FIGS. 1-4C, a system 10 is implemented on or as part of an IMS (IP Multimedia Subsystem) network 12, for transmitting multimedia advertisement data 14 to end-user terminals 16a, 16b. The system 10 includes an advertisement application server 18 and an advertisement media server 20, both interfaced with the IMS network 12. The advertisement application server 18 coordinates and manages operation of the system, for controlling if and when advertisement data 14 is to be transmitted to a particular user terminal. Under control of the advertisement application server 18, the advertisement media server 20 stores and transmits the advertisement data 14 to user terminals 16a, 16b. In operation, a communication link 22 is established with a user terminal 16a over the IMS network 12. Data 14 is then transmitted to the user terminal 16a from the advertisement media server 20. The advertisement data 14 is configured for execution on the user terminal 16a, meaning that the data 14 is processed by the user terminal for playback, display, etc. of an advertisement 24 on the user terminal according to the formatting and type of data present.

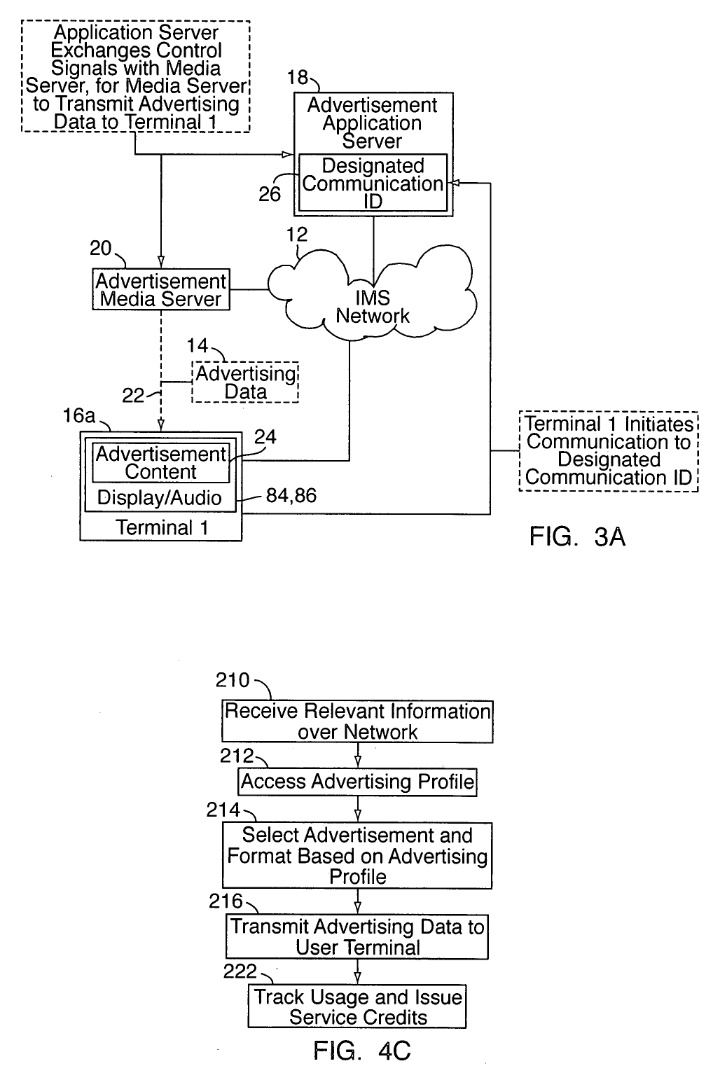

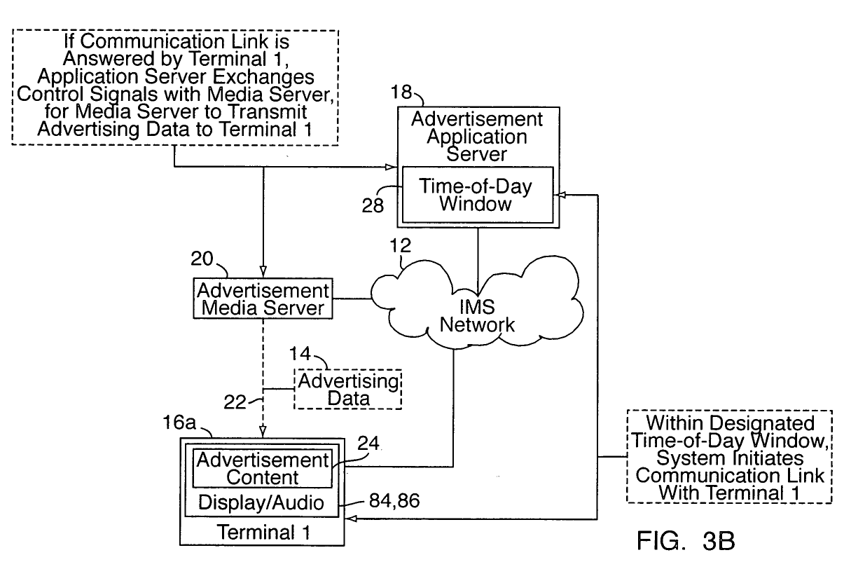

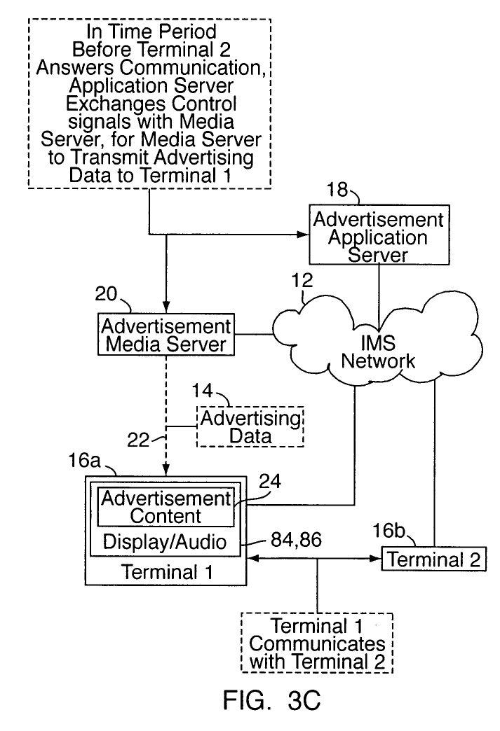

As discussed in more detail below, the system 10 includes three advertisement service functions that control under what circumstances advertisement data 14 is transmitted to a particular user terminal 16a. In the first, as shown in FIG. 3A, the user terminal 16a calls a designated phone number, or otherwise initiates communications over the IMS network 12 with a designated communication identifier 26. In response, the system transmits advertisement data 14 to the user terminal 16a. In a second, as shown in FIG. 3B, the advertisement application server 18 automatically transmits advertisement data 14 to the user terminal 16a within a designated time-of-day window 28. In a third, as shown in FIG. 3C, when the user terminal 16a calls a second user terminal 16b, the system 10 automatically transmits advertisement data 14 to the first terminal 16a (for execution of advertisements 24) until the call/communication is answered at the second terminal 16b.

The system 10 will typically be implemented on an IP Multimedia Subsystem (IMS) network 12. As the term is used herein according to its customary and normal meaning, “IMS network” refers to an IP multimedia and telephony core network as generally defined by 3GPP and 3GPP2 standards and organizations based on IETF Internet protocols. The IP Multimedia Subsystem is a standardized “next generation” networking architecture for providing multimedia services in mobile/wireless and fixed/wire-line communication networks. The IMS uses the Internet protocol (IP) for packet-data communications generally, and voice over IP (VoIP) for voice communications, based on a 3GPP/3GPP2 standardized implementation of SIP (session initiation protocol). (SIP is a signaling protocol used for establishing sessions, such as a two-way telephone call or multi-party phone conference, in an IP network.) The IMS works with any packet switched network, both wire-line based and wireless, such as GPRS, UMTS, CDMA2000, and WiMAX. Legacy circuit-switched phone systems and similar networks (e.g., POTS, GSM) are supported through gateways. The IMS includes session control, connection control, and an application services framework along with subscriber and services data. It enables the use of new converged voice and data services, while facilitating the interoperability of these converged services between subscribers.

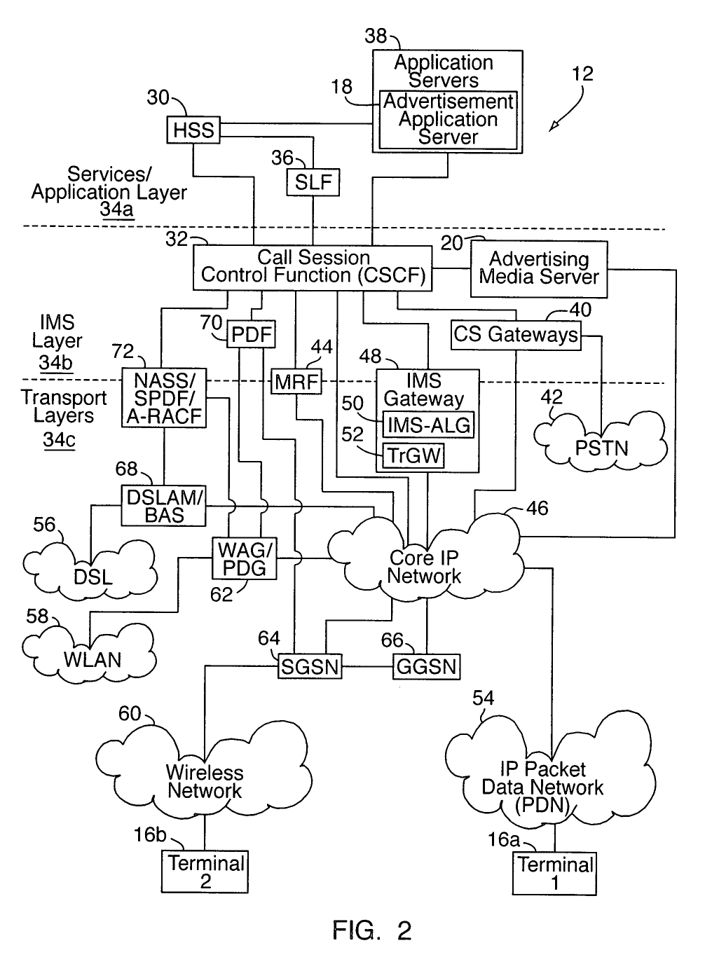

One example of an IMS-based network 12 is shown in simplified form in FIG. 2. The IMS control architecture includes a home subscriber server (“HSS”) 30 and a call session control function (“CSCF”) 32, and may generally be divided into a services/application layer 34a, an IMS layer 34b, and a transport layer 34c. The HSS 30 is the central repository of all subscriber-specific authorizations and service profiles and preferences. The HSS 30 integrates several functions/elements, some of which may exist already (for example, in the home location register of wireless networks), including subscriber/user profile database, subscriber service permissions, authentication and authorization, subscriber preference settings, mobile authentication server, and the like. An SLF 36 (subscriber location function) is needed when multiple HSS's are used. The CSCF 32 carries out the primary SIP signaling functions in the network. The CSCF 32 includes several types of SIP servers, including a proxy-CSCF server (the first point of contact for device and controls authentication), an interrogating-CSCF server (the entry point of all SIP messages), and a serving-CSCF server, which manages session control functions. Additionally, application servers 38 host and execute services, and interface with the CSCF 32 using SIP. This allows third party providers to easily integrate and deploy their value added services on the IMS infrastructure. Examples of services include caller ID related services, call waiting, call holding, push to talk, conference call servers, voicemail, instant messaging, call blocking, and call forwarding. A circuit-switched (“CS”) network gateway 40 interfaces the IMS network 12 with circuit-switched networks 42 such as a public switched telephone network (“PSTN”). The gateway 40 may include a BGCF (breakout gateway control function), which is an SIP server that includes routing functionality based on telephone numbers, an SGW (signaling gateway) that interfaces with the signaling plane of the network 42, an MGCF (media gateway controller function) for call control protocol conversion, and an MGW (media gateway) that interfaces with the media plane of the circuit-switched network 42. An MRF 44 (media resource function) may be provided as a media source in the network, e.g., for multimedia conferencing, text-to-speech conversation and speech recognition, and real-time transcoding of multimedia data, e.g., conversion between different codecs.

At the transport layer 34c, the IMS layer 34b is connected to a core broadband IP network 46, possibly through the MRF 44 and/or an IMS gateway 48. The IMS gateway 48 may include an IMS application layer gateway 50 (“IMS-ALG”) and a translation gateway 52 (“TrGW”) for facilitating communications with networks using different versions of the Internet protocol, e.g., IPv4 and IPv6. The core IP network 46 is also connected to one or more external IP packet data networks 54 (“IP PDN”), e.g., the Internet, and to other networks such as a DSL or other wire-line network 56, wireless local area networks (“WLAN”) 58, and wireless networks 60. Typically, one or more intermediate network elements are used for facilitating these connections, such as a WLAN access gateway (“WAG”) and/or WLAN packet data gateway (“PDG”) 62, a serving GPRS support node (“SGSN”) 64 and gateway GPRS service node (“GGSN”) 66, and a digital subscriber line access multiplexer (“DSLAM”) and broadband access server (“BAS”) 68. The SGSN 64 is responsible for mobility management and IP packet session management. It routes user packet traffic from the wireless network 60 to the appropriate GGSN 66, providing access to external packet data networks, in this case the core network 46. The DSLAM 68 is a network device, usually located at a telephone company central office, or within a neighborhood serving area interface as part of a digital loop carrier, that receives signals from multiple customer DSL connections and aggregates the signals on a high-speed backbone line using multiplexing techniques. In this case, the DSLAM 68 connects the DSL network 56 with the core IP network 46.

The networks 56, 58, 60 may be functionally/logically connected to the CSCF 32 through various control/functional elements. For example, the IMS system may include a policy decision function (“PDF”) 70, which enables the access network to be managed using dynamic policies. Additional functional elements 72 (grouped together for simplicity of illustration) may include a service policy decision function (“SPDF”), an access-resource and admission control function (“A-RACF”), and a network attachment subsystem (“NASS”). The SPDF, for example, makes policy decisions using policy rules and forwards session and media related information, obtained from an application function, to the A-RACF for admission control purposes. The A-RACF is a functional element that performs resource reservation admission control and network policy assembly functions. For simplicity of illustration, some intermediate network elements such as access gateways and server nodes are not shown. Further explanation regarding the operation of an IMS network is available in the literature, and is known to those skilled in the art.

In an IMS-based network 12, as is generally the case with other communication networks, end-user terminals 16a, 16b provide a means for users to communicate with one another over the network(s). Each terminal is an electronic device with hardware and/or software-based functionality for communicating over a network, and typically including user input/output means such as a keyboard and display. Examples include computer terminals, as well as wireless units such as mobile phones, wireless PDA's, wireless devices with high-speed data transfer capabilities, such as those compliant with “3-G” or “4-G” standards, “WiFi”—equipped computer terminals, and the like. When one terminal 16a initiates communication with another terminal 16b, various signaling procedures are automatically carried out by the network, according to its communication protocols, in an attempt to open a communication link between the two terminals. Once a communication link is established, the terminals 16a, 16b communicate with one another over the network 12 in a standard manner, depending on the particular networks used and the particular type of terminals. For example, in the case of wireless units and a wireless network 60, the network 60 may include one or more fixed base stations (not shown) having various transceivers and antennae for wireless, radio-frequency (RF) communications with the wireless units over one or more RF channels, in a manner based on the wireless communication method and protocol used. A radio network controller interconnects the base stations and performs the signaling functions necessary to establish calls and other data transfer to and from the wireless units. It also acts as the interface between the wireless/RF end of the network and the wire-line portion of the network, including the IMS and other networks.

As noted above, the system 10 includes an advertisement application server 18 and an advertisement media server 20, both interfaced with the IMS network 12, e.g., as shown in FIG. 2. The advertisement application server 18 coordinates and manages operation of the system 10, for controlling if and when advertisement data 14 is to be transmitted to a particular user terminal. (As should be appreciated, within the context of the IMS network, the advertisement application server 18 is one of the application servers 38.) Under control of the advertisement application server 18, the advertisement media server 20 transmits the advertisement data 14 to user terminals 16a, 16b. Thus, when it is determined at the advertisement application server that advertisements are to be transmitted to a user terminal, the advertisement application server communicates with the advertisement media server and/or IMS network for initiating the advertisement data transmission process. The IMS network controls the media negotiation between the user terminal and the advertisement media server, based on the media supported by the advertisement media server and user terminal, as well as on the media type of the advertisement and (optionally) a user preference for the advertisement type and/or advertisement media type.

The system 10 includes several advertisement functions that control when advertisement data is transmitted to a user terminal. These include (i) the user terminal calling a designated telephone number 26 to receive advertisements (FIG. 3A), (ii) the system automatically calling the user terminal to deliver advertisements (FIG. 3B), and/or (iii) the system automatically transmitting advertisements when the user terminal calls another user terminal, before the call is answered or if the calling terminal is put on hold (FIG. 3C).

In the case of a designated phone number or other communication identifier 26, end users are made aware of the designated communication identifier 26 by way of advertisements, product announcements, as part of the network service provider's service plan, or the like. End users are informed that if they call (or otherwise communicate with) the designated communication identifier 26, the system 10 will transmit advertisement data 14 to their terminals 16a, 16b once a communication link 22 is established. As part of this process, each user may be provided with the option of setting up an advertising profile 80. The advertising profile 80 is a data record stored on the IMS network HSS 30 as part of (or in association with) the user's account or service profile 82 on the HSS. The advertising profile 80 may include (i) terminal information 88 about the multimedia capabilities of the user's phone or other terminal 16a, and/or (ii) a list 90 of advertising-related preferences and/or user demographic characteristics. The terminal information 88 includes information about what data formats the terminal is capable of receiving and executing, whether the user terminal includes a display/monitor 84 (and the configuration of the display/monitor), audio capabilities 86, terminal processor type, speed, and memory, information on the bandwidth available to the terminal for receiving multimedia or other advertisement data, and the like. The advertising preferences list 90 is used for tailoring the advertisements 24 to the characteristics and/or personal preferences of the particular end user in question. Thus, the list 90 may include demographic information of the end user (e.g., age, sex, income level, and ethnicity), information about products that the end user owns or has owned in the past, categories of goods, services, and information that the user is interested in, and/or a desired media type for the advertisement. For example, the user may prefer to receive video-only advertisement data, or sound only advertisement data, or low-resolution advertisements.

The advertising profile 80 may include other categories of information, such as the time-of-day window 28. It may also include a global selection for the user to opt-in to the advertising service (or to opt-in to only one or two of the service functions) or completely opt-out of the advertising service, or to opt-out of one or two of the service functions. Information in the advertising profile 80 may be user selected or user configured. Alternatively, some or all of the information in the advertising profile may be generated by the system 10, with or without the possibility of user modification. For example, the system 10 may be “open” in nature, with end users being able to select and configure all the information in their respective profiles 80. Alternatively, the system 10 may be “closed,” wherein the system transmits advertisements to end users without any input or configuration by the end users. Still further, the system 10 may allow user configuration for certain of the system advertising functions, but not for others. For example, in the case where users call a designated phone number 26 for receiving advertisements, it is more often the case that advertisers will want to transmit advertisements that the users are actually interested in receiving and reviewing. However, in the case of advertisements being transmitted to end users when they call other parties, the called party may want to dictate what advertisements are transmitted to the end user.

For a user to call (or otherwise communicate with) a designated communication identifier 26, communications over the network are initiated at the end-user terminal 16a in a standard manner, depending on the type of designated communication identifier 26 used in the system. For example, if the communication identifier 26 is a phone number and the terminal 16a is a mobile phone, the user enters the phone number 26 into the terminal 16a and selects the “call send” function. The call is processed by the network 12 in a standard manner, with the advertisement application server 18 being informed (through signaling protocols in place on the network) that communications with the designated identifier 26 have been initiated at the terminal 16a. The communication identifier of the terminal 16a is cross-referenced to the HSS 30. The advertisement application server 18 accesses the advertising profile 80 associated with the terminal 16a. Assuming that the terminal has not opted out of receiving advertisements, the advertisement data 14 for transmission to the terminal is configured according to the advertising profile 80. This includes formatting or selecting the data 14 according to the capabilities of the terminal 16a (as indicated in the terminal information 88), and selecting the data 14, as relating to its advertising content, according to the advertising preferences 90. Thus, for example, the advertisement media server 20 may include (or have access to) a databank of digitally stored advertisements 92, which are divided into different categories based on advertising content. The system accesses the advertising preferences lists 90, and selects one of the advertisements 92 based on the preferences. For example, if the preferences list indicates that the user is interested in receiving information about automobile-type vehicles, then the system selects a car-related advertisement 92. Subsequently, the selected advertisement is formatted according to the terminal information 88 in the advertising profile 80. For example, if the terminal information 88 indicates that the terminal 16a has a high-bandwidth forward link connection (for receiving data), then the selected advertisement is formatted/selected to have a high bandwidth content, e.g., high resolution video and audio. On the other hand, if the terminal information 88 indicates that the terminal 16a has a low-bandwidth forward link connection, then the selected advertisement is formatted/selected to have a low bandwidth content, e.g., lower resolution video and audio. The selected advertisement may be further formatted according to other information in the advertising profile 80, such as omitting sound if the terminal is indicated as lacking audio playback capability.

Once a stored advertisement 92 is selected, and subsequent to (or concurrently with) configuring the data based on the advertising profile 80 associated with the terminal 16a, the advertisement media server 20 transmits the data 14 in the selected advertisement to the terminal 16a over the network 12 in a standard manner. (It is assumed here that the network 12 has completed establishing a communication link 22 for the terminal 16a to receive data over the network.) The advertisement data 14 is received at the terminal 16a, where it is stored (if necessary) and executed in a standard manner, depending on the terminal's hardware/software configuration and the format of the transmitted data 14, for generation/replication of the advertisement 24. For example, in the case of a multimedia advertisement, video or other picture content of the advertisement is played back on the terminal's screen, monitor, or other video output 84, and audio or sound content of the advertisements is outputted through the terminal's speaker(s) or other audio output means 86. In a standard manner, advertisements can either be downloaded and then executed, or executed as they are downloaded (e.g., streaming content). If the terminal 16a is subsequently deactivated, or the communication link terminated, then the system stops transmitting advertisement data 14. On the other hand, if the system has completed transmitting an advertisement and the terminal 16a is still active, then the system may either transmit another advertisement or terminate the connection 22 to the terminal 16a, depending on how the system is configured and/or based on the terminal's advertising profile 80.

The system 10 may be configured to monitor the advertisement consumption activities of end-user terminals, and for crediting users with telephony service credits based on the monitored consumption. To elaborate, as advertisement data 14 is transmitted to the terminal 16a, the system optionally tracks which advertisements 24 have been received and executed at the terminal. This information may be used for accounting purposes (e.g., for billing advertisers), for tracking system usage generally, and/or for crediting users who view the advertisements. In particular, user terminals 16a, 16b may be given service credit 94 based on the type and/or number of advertisements executed on the user terminals. As noted above, service credit refers to monetary or other value redeemable for one or more services over the network, e.g., monetary credit towards the user's monthly bill, free downloads or long distance, prepaid call credits, toll-free calls of a certain duration, free short message service for a particular number of messages, and the like. Offering service credits is an incentive for users to call the designated communication identifier 26 and view advertisements 24. Typically, the advertisement application server 18 will inform the network billing system of the user service credits, which the user can check by accessing the billing system's customer interface, e.g., an account access website.

For the advertisement service functions described herein, users may be required to specifically register with the IMS network 12 for receiving advertisements. Registration may be carried out in one of several standard ways, such as over a designated website, by calling a service provider customer service center, by selecting a terminal-based menu function, or when a network account is initially established. Users may register for only one of the advertising services, or for more than one, in any combination. Users may be required to consent to a advertisement service provider agreement, in accordance with which the service provider and/or user will set up the advertising profile 80 in the HSS subscriber database 30. The advertisement application server 18 may also include a database (not shown) for storing user terminal-related information (e.g., for storing advertising profiles 80), separate from or in conjunction with what is stored in the HSS 30. In such a case, advertising profiles are also set up in the database of the advertisement application server.

For calling a designated communication identifier to receive advertisements over the system 10 (FIG. 3A), operation of the system 10 is summarized in FIGS. 4A, 4B, and 4C, with respect to operations at the terminal 16a, network 12, and advertisement media server 20 (or system 10 generally), respectively. At Step 200 in FIG. 4A, communications are initiated at the terminal 16a to a designated communication identifier 26. For example, it may be the case that the user enters a designated phone number into the terminal 16a and selects a “call send” function. At Step 202, the network 12 receives signaling data from the terminal 16a indicating that the terminal desires to establish communications with the network entity associated with the designated communication identifier 26. At Step 204, the network 12 transmits to the advertisement application server 18 whatever information is required under the system 10 for carrying out data transmission. For example, the network may send the communication identifier of the terminal 16a to the server 18, for cross-referencing to the HSS 30. At Steps 206 and 208, additional communication signaling may be carried out between the terminal, network, and advertisement servers 18, 20 for establishing a communication link 22 from the advertisement media server 20 to the terminal 16a. At Step 210, the advertisement application server 18 receives the terminal information provided by the network in Step 204. At Step 212, the advertisement application server 18 accesses the advertising profile 80 associated with the terminal 16a. At Step 214, the advertisement application server 18 selects and configures an advertisement from among the advertisements 92 stored in the system 10, based on the advertising profile 80. At Step 216, the advertisement media server 20 transmits multimedia advertisement data 14 to the terminal 16a, where it is received at the terminal 16a in Step 218. At Step 220, the terminal 16a executes the data 14 for playback of the advertisement content 24. At Step 222, the system 10 tracks the advertisements executed on the terminal 16a, and optionally issues service credits in correspondence there with.

In another advertisement service function available on the system 10, instead of communications being initiated at the user terminal 16a, the system 10 initiates communications with the user terminal 16a for transmitting multimedia advertisements. See FIG. 3B. This may be done on a random or service provider-scheduled basis, e.g., the system 10 initiates communications with end-user terminals at times established by the advertisers or service provider. (Typically, users will have consented to receiving such communications, but this is not necessarily the case.) Alternatively, users may select or establish time-of-day windows 28 in which they wish to receive advertising-related communications from the system 10. Here, when the user signs up for or otherwise consents to the service, and as part of the process for setting up an advertising profile 80, the user selects a time-of-day window 28, which is stored in the user's advertising profile 80 on the HSS 30. (The system 10 may or may not include a default time-of-day window, which the user can modify.) “Time-of-day window” refers to a designated time range as defined by at least one start time, and more typically by a start time in conjunction with a stop time. Therefore, this includes both a single designated time (e.g., “4 pm”, meaning that the system can only attempt to contact a user terminal 16a at 4 pm), and a range of times, e.g., “4 pm-10 pm”, meaning that the system can attempt to contact the user terminal at any time between 4 pm and 10 pm, where the start and stop times are defined with respect to a pre-designated clock, typically the local time where the user is located, GMT, or the like. Time-of-day window also contemplates generalized designations, such as “morning,” “afternoon,” and “evening,” where the system may be configured to account for typical social norms for calls within these time frames. For example, an “evening” designation might be understood to refer to calls after the dinner hour but before bedtime, e.g., between 7 pm and 10 pm. The system may be configured for the user to designate more than one time-of-day window.

In operation, the advertisement application server 18 maintains a list or database of the designated time-of-day windows for user terminals 16a, 16b. For a given terminal 16a, when the actual time corresponds to the designated time-of-day window, the system 10 interacts with the network 12 for initiating communications with the terminal 16a, in an attempt to establish a communication link 22 with the terminal 16a. Concurrently, the system 10 selects (and possibly configures) an advertisement 92 for transmission, based on the advertising profile 80 associated with the terminal 16a. As part of this initial process, in addition to the terminal 16a outputting a general purpose call-pending alert (such as a ring tone), a call-pending indicator may be displayed on the terminal 16a for informing the user that the pending communication link is associated with the advertising service. The displayed indicator may be a communication identifier associated with the service (e.g., caller ID), which the user would be expected to recognize. Alternatively, text or graphics may be displayed for informing the user that there is an incoming advertisement. In either case, based on the displayed indicator, the user makes a choice of whether or not to answer the pending call or other communication. For example, it may be the case that the user is busy with another task and cannot devote the time to view an advertisement. If the user decides not to answer the pending communication, the system 10 may re-try within the designated time-of-day window, after a pre-selected wait time (e.g., 5-10 minutes), and until the user answers one of the attempted communications. If the user answers the communication, then selected multimedia advertisement data 14 is transmitted to the terminal 16a as discussed above, for execution of an advertisement 24 over the terminal's audio/video outputs 84, 86.

If the system 10 initiates communication with an end-user terminal 16a, it may be the case that instead of the communication being answered or remaining unanswered, a call forwarding or transfer operation is automatically carried out by the network 12 for routing the communication to another designated terminal. The system 10 may be configured to transmit advertisement data to the transferred/forwarded terminal. Alternatively, advertising profiles 80 may include a field for users to select whether to have advertisements forwarded in this situation. Here, upon the occurrence of a forwarding or transfer operation, the system accesses the advertising profile of the end-user terminal in question. If the forwarding/transfer field indicates that advertisements are not to be transferred, the communication is terminated. Otherwise, a communication link is established with the transfer/forward terminal, if possible, with advertisement data being transmitted to the transfer/forward terminal in the manner as described above.

In another advertisement service function available on the system 10, the system automatically transmits advertisements 14 when one user terminal 16a initiates communication with another user terminal 16b, before the call is answered or if the calling terminal is put on hold. See FIG. 3C. Here, when a first terminal 16a initiates communication with a second terminal 16b, before the communication is answered at the second terminal 16b, the advertisement application server 18 causes an advertisement media flow 14 to be directed the first terminal 16a. When the second terminal 16b answers the call, the system stops transmitting the advertisement data 14, and the system/network finishes establishing a communication link between the two terminals 16a, 16b. (Advertisement data may also be transmitted to the first terminal if the first terminal is put “on hold” by the second terminal.) Before transmitting advertisement data 14, the system may access the advertising profile 80 of the calling terminal 16a to determine if the terminal is subscribed or otherwise designated for receiving advertisements, either generally or with respect to this particular service. Alternatively, the transmission of advertisement data may be non-optional, and without reference to an advertising profile 80. For example, the system 10 may be used by called parties 16b as an “on hold” content mechanism, or for otherwise providing calling parties 16a with information about the called parties 16b prior to the communication being answered by the called party 16b, e.g., a business greeting, business announcement, or the like.

Although the system of the present invention has been illustrated as using advertising profiles 80 for selecting advertisements to transmit to end-user terminals (and/or for configuring the data with respect to the terminals' functional characteristics, feature sets, etc.), advertisements may instead be transmitted based on advertiser-selected or service provider-selected criteria, and/or according to default configurations meant to be generally applicable/compatible with different types of end-user terminals in an IMS network.

Signaling functions between the server entities 18, 20 and the IMS network 20 can be implemented in a standard manner, as known to those skilled in the art. Similarly, advertising functions can be implemented in software using standard programming methods.

Since certain changes may be made in the above-described advertisement application server and system for delivering multimedia advertisements to end-user terminals in an IMS network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of communicating with a user terminal over an IP multimedia subsystem (IMS) network, said method comprising:
establishing a communication link with the user terminal over the IMS network; and
transmitting data to the user terminal, said data containing advertising content for execution on the user terminal.

2. The method of claim 1 wherein the data is multimedia data containing picture advertising content and sound advertising content for playback of an advertisement on the user terminal.

3. The method of claim 2 further comprising:
prior to transmitting the multimedia data to the user terminal, configuring the multimedia data based on an advertising profile associated with the user terminal.

4. The method of claim 3 wherein the multimedia data is transmitted to the user terminal within a time-of-day window designated in the advertising profile, said communication link being established automatically within the time-of-day window without initiation of the communication link by the user terminal.

5. The method of claim 3 wherein the advertising profile is stored on a home subscriber server portion of the IMS network.

6. The method of claim 3 wherein the multimedia data is configured by selecting the advertising content of the multimedia data according to the advertising profile associated with the user terminal.

7. The method of claim 2 further comprising:
at the user terminal, initiating communication with a second terminal over the IMS network, wherein the multimedia data is transmitted to the user terminal subsequent to the user terminal initiating communication with the second terminal; and
halting transmission of the multimedia data if the communication initiated by the user terminal is answered by the second terminal.

8. The method of claim 2 further comprising:
displaying an indicator on the user terminal that the communication link is associated with said advertising content, wherein the advertising content is only executed on the user terminal if the communication is answered at the user terminal.

9. The method of claim 2 further comprising:
at the user terminal, initiating communications with a second terminal over the IMS network, wherein the communication link with the user terminal is established by an advertisement application server subsequent to the user terminal initiating communications with the second terminal, said advertisement application server being interfaced with the IMS network;
subsequent to the communication link being established, transmitting the multimedia data to the user terminal from an advertisement media server interfaced with the IMS network; and
halting transmission of the multimedia data if the communication initiated by the user terminal is answered by the second terminal.

10. The method of claim 9 further comprising:
prior to transmitting the multimedia data to the user terminal, configuring the multimedia data based on an advertising profile associated with the user terminal.

11. The method of claim 2 further comprising:
displaying an indicator on the user terminal that the communication link is associated with said advertising content, said communication link being established by an advertisement application server interfaced with the IMS network; and,
upon the communication link being answered at the user terminal, executing the advertising content on the user terminal, said multimedia data being transmitted to the user terminal from an advertisement media server interfaced with the IMS network.

12. The method of claim 2 further comprising:
generating a call record containing data relating to the advertising content executed on the user terminal, wherein the call record is associated with the user terminal.

13. The method of claim 2 further comprising:
initiating establishment of the communication link at the user terminal according to a designated communication identifier entered into the user terminal, said communication identifier being associated with an advertising service terminal in the IMS network.

14. A method of communicating over a network, said method comprising:
initiating a communication over the network between a first terminal and a second terminal, said second terminal being an end-user phone terminal; and
transmitting multimedia data to the second terminal, wherein the multimedia data is configured for generation of an advertisement on the second terminal, said advertisement including picture content and sound content.

15. The method of claim 14 further comprising:
prior to transmitting the data to the second terminal, configuring the data based on an advertising profile associated with the second terminal.

16. The method of claim 15 wherein:
the communication between the first and second terminals is automatically initiated by the first terminal within a time-of-day window designated in the advertising profile; and
the data is transmitted to the second terminal within said time-of-day window.

17. The method of claim 15 further comprising selecting said advertisement based on the advertising profile associated with the second terminal, said selected advertisement being one of a plurality of advertisements available for transmission to end-user terminals over the network.

18. The method of claim 14 wherein:
the first terminal is an end-user phone terminal;
the communication between the terminals is initiated at the second terminal; and
the data is transmitted to the second terminal only until the communication is answered at the first terminal, said data being transmitted from an advertisement media server interfaced with the network.

19. The method of claim 14 wherein:
the network is an IP multimedia subsystem (IMS) network having a media server; and
the data is transmitted to the second terminal from the IMS network media server.

20. An advertisement system for an IP multimedia subsystem (IMS) network, said system comprising:
an advertisement application server interfaced with the IMS network for managing the transmission of advertisement data to end-user terminals in the IMS network; and
an advertisement media server interfaced with the IMS network for transmitting designated multimedia advertisement data to said end-user terminals;
wherein the advertisement application server is configured to control the advertisement media server to transmit advertisement data to a first of said end-user terminals: (i) when the first terminal initiates communication over the network to a communication identifier associated with an advertisement playback service, wherein the advertisement application server generates a service credit for the first terminal based on the advertisement data transmitted to the first terminal; (ii) within a time-of-day window designated by a user of the first terminal, said advertisement application server automatically initiating communications with the first terminal within the designated time-of-day window; and (iii) when the first terminal initiates communications with a second end-user terminal, said advertisement media server transmitting the advertisement data to the first terminal until the communication initiated by the first terminal is answered at the second terminal, wherein the advertisement data is configured for automatic execution on the first terminal for playback of a multimedia advertisement.
